(19) United States
(12) Patent Application Publication
(10) Pub. No.: US 2012/0140467 A1
(43) Pub. Date: Jun. 7, 2012

(54) LED LAMP

(75) Inventor: Kuo-Cheng CHANG, Chu-Nan (TW)

(73) Assignee: FOXSEMICON INTEGRATED TECHNOLOGY, INC., Chu-Nan (TW)

(21) Appl. No.: 13/288,090

(22) Filed: Nov. 3, 2011

(30) Foreign Application Priority Data
Dec. 6, 2010 (TW) 099142277

(51) Int. Cl. F21V 5/04; F21V 21/00

(52) U.S. Cl. 362/235; 362/249.02

(57) ABSTRACT

A portable light emitting diode (LED) lamp is disclosed. The light emitting diode (LED) lamp, the LED lamp comprises a main body; a first LED module arranged at a first end of the main body; a holder arranged at a second end of the main body; and a second LED module pivotally connected to the holder.

### BACKGROUND

1. Technical Field

The present disclosure relates to a light emitting diode (LED) device, and particularly to a portable LED lamp as a reading lamp or a flashlight.

2. Discussion of Related Art

Light emitting diodes' (LEDs) have many advantages, such as high luminosity, low operational voltage, low power consumption, compatibility with integrated circuits, easy driving, long term reliability, and environmental friendliness. These advantages have promoted a wide use of LEDs as lighting sources.

However, conventional LED lamps may only have a single function, such as a flashlight, or as a reading light. Users need different types of lamps for different functions, which may be costly.

Therefore, what is needed is an LED lamp which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled view of an LED lamp in a first state in accordance with an embodiment of the present disclosure.

FIG. 2 is a cross-sectional view of the LED lamp of FIG. 1, taken along line II-II thereof.

FIG. 3 is an assembled view of the LED lamp of FIG. 1, but in a second state.

FIG. 4 is an assembled view of the LED lamp of FIG. 1, but in a third state.

### DETAILED DESCRIPTION OF EMBODIMENTS

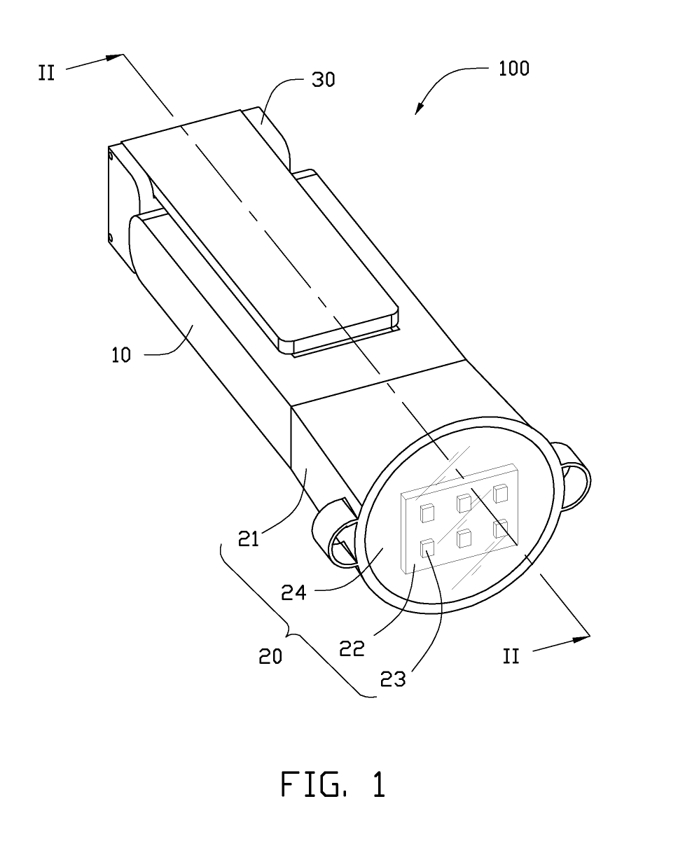

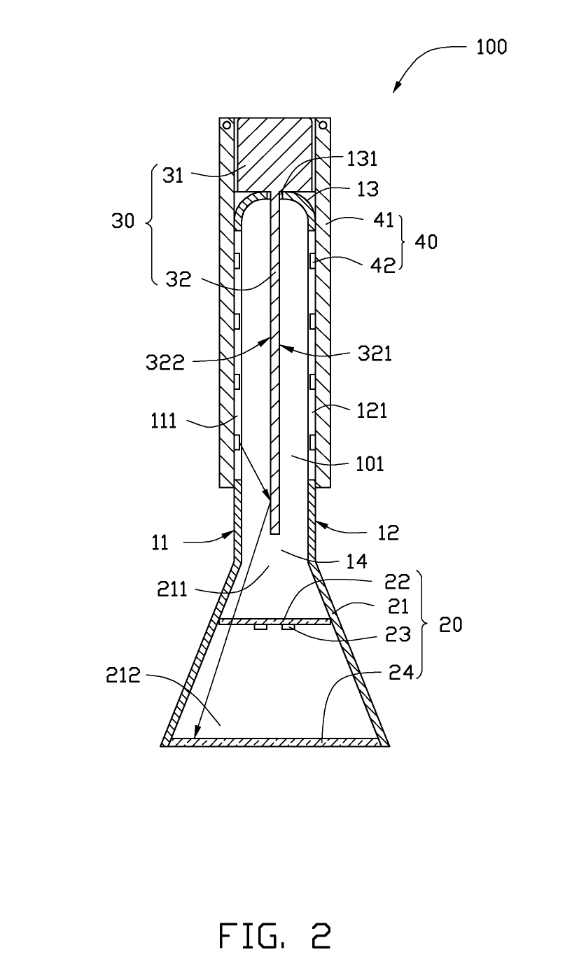

Referring to the FIGS. 1-2, an LED lamp 100, in accordance with an embodiment is shown. The LED lamp 100 may comprise a main body 10 having a first end and a second end, a first LED module 20 fixed to the first end, a holder 30 mounted on the second end, and a second LED module 40 pivotally connected to the holder 30.

The main body 10 is elongated and has a rectangular cross section. The main body 10 includes a first surface 11, a second surface 12 opposite to the first surface 11, and an end surface 13 connecting rear ends of the first surface 11 and the second surface 12. The main body 10 is hollow and defines a chamber 101 therein. The main body 10 defines a first opening 14 at the first end. The first surface 11 defines a first window 111 at a central portion thereof. The second surface 12 defines a second window 121 at a central portion thereof. The third surface 13 defines a slot 131 at a center thereof. The first window 111, the second window 121, and the slot 131 are interconnected with the chamber 101.

The first LED module 20 includes a lampshade 21, a supporting board 22, a plurality of LEDs 23 arranged on the supporting board 22, and a lens 24.

The lampshade 21 is hollow cone-shaped, and defines a second opening 211 and a third opening 212 at two opposite ends thereof. The third opening 212 is larger than that of second opening 211. The second opening 211 is the same as the first opening 14 of the main body 10 in size and shape. The lampshade 21 of the first LED module 20 is connected to the first end of the main body 10, and the first opening 14 of the main body 10 is interconnected with the second opening 211 of the lampshade 21.

The supporting board 22 is received in the lampshade 21. In the present embodiment, the supporting board 22 is transparent and made of glass. The supporting board 22 is fixed on an inner wall of the lampshade 21. The plurality of LEDs 23 are arranged on a same side of the supporting board 22 and opposite to the lens 24. The lens 24 covers the third opening 212 of the lampshade 21.

The holder 30 is moveably engaged with the third end surface 13 of the main body 10. In the present embodiment, the holder 30 includes a rectangular base 31 and an elongated rectangular substrate 32 extending from the base 31. The elongated rectangular substrate 32 is made of metallic material with a high light reflectivity, and includes a first reflective surface 321 facing the second window 121, and a second reflective surface 322 facing the first window 111. A reflective area of the first reflective surface 321 is larger than an area of the second window 121, and a reflective area of the second reflective surface 322 is larger than an area of the first window 111. The elongated rectangular substrate 32 is inserted into the chamber 101 of the main body 10 through the slot 131, and may be telescopically moved along an axial direction of the main body 10.

The second LED module 40 is pivotally connected to the holder 30. The second LED module 40 includes two planar plates 41 and a plurality of second LEDs 42 arranged on the two planar plates 41. The two planar plates 41 are pivotally connected to two sides of the holder 30, and may be rotated to attach to or detach from the main body 10.

As shown in FIG. 1, the LED lamp 100 is at a first state, functioning as flashlight. In the first state, the two planar plates 41 are rotated to overlap with the first surface 11 and the second surface 12. The first window 111 and the second window 121 are covered in the first state. The plurality of second LEDs 42 are received in the first and second windows 111, 121, facing the first reflective surface 321 and the second reflective surface 322. Light emitted from the plurality of second LEDs 42 is reflected by the elongated rectangular substrate 32 on the first reflective surface 321 and the second reflective surface 322, and then travels through the lens 24 to provide illumination. Light emitted from the plurality of LEDs 23 of the first LED module 10 also travels through the lens 24 to provide additional illumination. It should be understood that, either the first LED module 20 or the second LED module 40 alone may provide enough light intensity. It is not necessary to turn on both the first LED module 20 and the second LED module 40 for the LED lamp 100 to function as a flashlight according to the present disclosure.

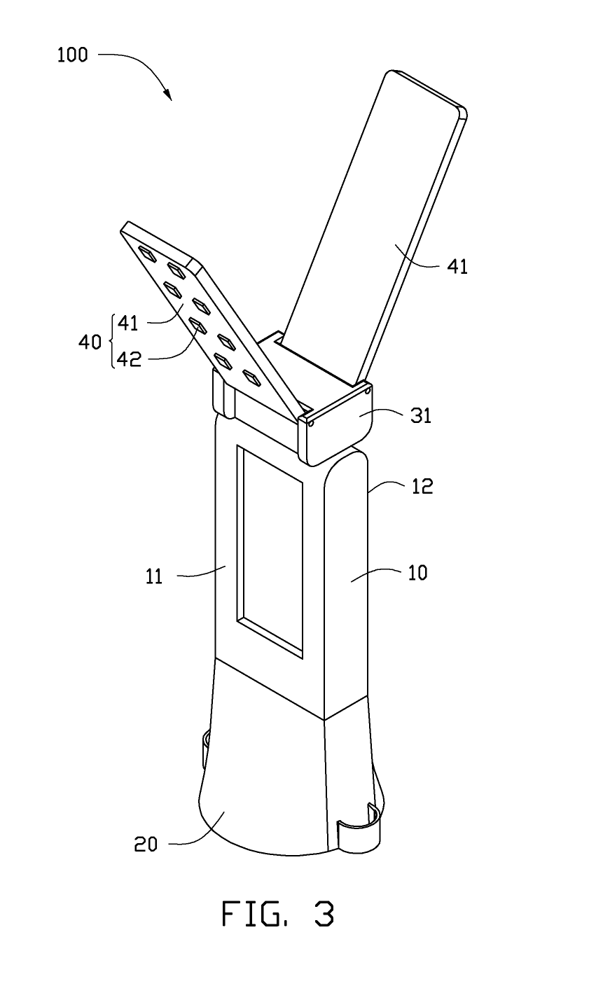

Referring to the FIG. 3, wherein the LED lamp 100 is changed from the first state to a second state, functioning as first reading light. In the second state, the two planar plates 41 are rotated out away from the main body 10 and upwardly relative to the rectangular base 31. Each of the two planar plates 41 and the corresponding first surface 11 or the second surface 12 of the main body 10 cooperatively form an obtuse angle therebetween. In the second a state when the LED lamp 100 functions as a first reading light, only the plurality of second LEDs 42 of the second LED module 40 provide light, and the first LED module 20 may be turned off.

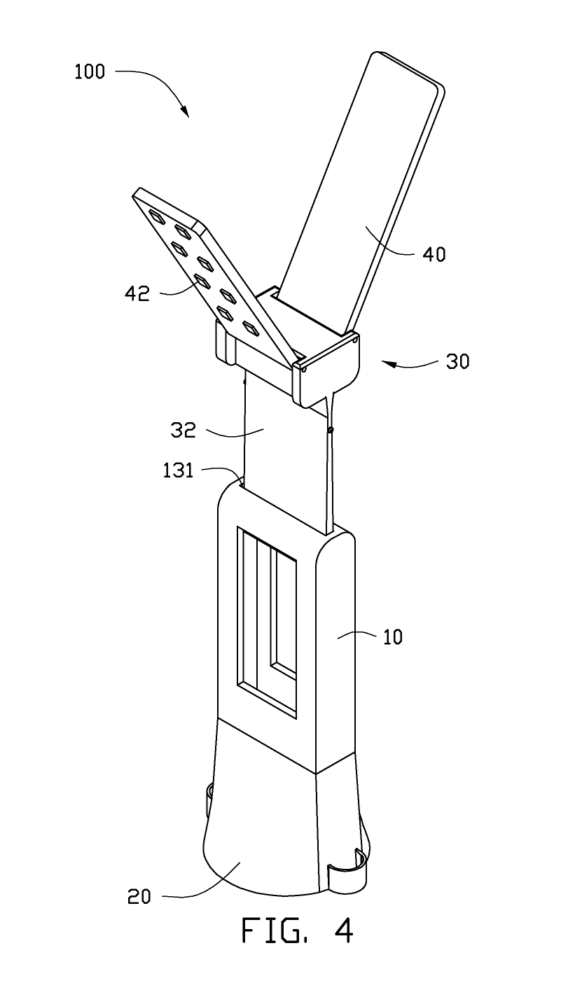

Referring to the FIG. 4, wherein the LED lamp 110 is in a third state, functioning as a second reading light. In FIG. 4, the elongated rectangular substrate 32 of the holder 30 is partially drawn outwards from the slot 131, thereby adjusting a height of the second LED module 40. In alternative embodiments, the two planar plates 41 and the main body 10 can cooperatively form an acute angle or a right angle, and only one of the two planar plates 41 can be rotated upwardly. In the third state when the LED lamp 100 functions as a second reading light, only the plurality of second LEDs 42 of the second LED module 40 provide light, and the first LED module 20 may be turned off.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A light emitting diode (LED) lamp, the LED lamp comprising:
a main body;
a first LED module arranged at a first end of the main body;
a holder arranged at a second end of the main body; and
a second LED module pivotally connected to the holder.

2. The LED lamp of claim 1 further comprises a slot at the second end of the main body, the holder comprising a base and a substrate extending from the base through the slot of the main body.

3. The LED lamp of claim 2, the second LED module comprises two plates and a plurality of second LEDs arranged on the two plates; wherein each of the plates is pivotally connected to two opposite sides of the base of the holder, and faces the main body.

4. The LED lamp of claim 1, wherein the main body is hollow and defines a chamber therein, the main body comprising a first surface, a second surface opposite to the first surface, and an end surface arranged between the first surface and the second surface, a slot being defined in the end surface.

5. The LED lamp of claim 4, wherein the main body defines a first opening at the first end; the first LED module comprising a hollow lampshade connected to the first end of the main body, and a plurality of first LEDs received in the hollow lampshade.

6. The LED lamp of claim 5, the first LED module further comprises a transparent supporting board fixed on the hollow lampshade, wherein the plurality of first LEDs are arranged on the transparent supporting board.

7. The LED lamp of claim 5, the first surface of the main body comprises a first window; the second surface of the main body comprises a second window, wherein the first window and the second window are interconnected with an interior of the hollow lampshade.

8. The LED lamp of claim 7, the second LED module comprises two plates; and a plurality of second LEDs arranged on the two plates, wherein each of the two plates is pivotally connected to two opposite sides of the holder, each of the two plates covers each of the first window and the second window, and the plurality of second LEDs are received in the first window and the second window.

9. An LED lamp, the LED lamp comprising:
a hollow main body comprising a first surface, a second surface opposite to the first surface, and a third surface arranged between the first surface and the second surface;
a first LED module arranged on the hollow main body away from the third surface;
a holder arranged at the third surface of the hollow main body; and
a second LED module comprising two plates, and a plurality second LEDs arranged on the two plates, wherein each of the two plates is pivotally engaged with each of two opposite sides of the holder, and the plurality of second LEDs are arranged between the hollow main body and the two plates when each of the two plates covers each of the first surface and the second surface of the hollow main body.

10. The LED lamp of claim 9, the first surface of the hollow main body comprises a first window, the second surface of the hollow main body comprises a second window, wherein the first window, the second window and the main body are interconnected with each other, each of the two plates covers each of the first window and the second window, and the plurality of second LEDs are received in the first window and the second window.

11. The LED lamp of claim 9, the holder comprises a base and a substrate arranged on the base, the third surface of the hollow main body comprises a slot, wherein the substrate is retractable into the slot.

12. The LED lamp of claim 11, wherein an area of the substrate is larger than either an area of the first window of an area of the second window, and the substrate is made of metallic materials with a light reflectivity.

13. The LED lamp of claim 9, the first LED module comprises a lampshade, and a plurality of first LEDs received in the lampshade, wherein the lampshade is connected with the hollow main body.

14. The LED lamp of claim 9, the hollow main body comprises a first opening opposite to the third surface, a lampshade having a hollow cone shape with a second opening and a third opening, and a lens; wherein the second opening is smaller than the third opening, and the second opening is connected to the hollow main body, and the lens covers the third opening.
